(19) United States
(12) Patent Application Publication
(10) Pub. No.: US 2017/0061349 A1
(43) Pub. Date: Mar. 2, 2017

(54) METHODS AND SYSTEMS IN EVALUATING AND SELECTING A COMBINATION OF SHIPPING PACKAGES

(71) Applicant: Wal-Mart Stores, Inc., Bentonville, AR (US)

(72) Inventor: Lu Zhang, Harrison, NJ (US)

(21) Appl. No.: 15/251,585

(22) Filed: Aug. 30, 2016

Related U.S. Application Data
(60) Provisional application No. 62/212,313, filed on Aug. 31, 2015.

(51) Int. Cl. G06Q 10/06; G06Q 10/08

(52) U.S. Cl. CPC G06Q 10/06313; G06Q 10/087

(57) ABSTRACT

In some embodiments, apparatuses and methods are provided herein useful to evaluate shipping packaging used at a distribution facility. Some embodiments provide a system to evaluate packaging, comprising: an evaluation control circuit and memory storing computer instructions executed by the control circuit causing the control circuit to: for each of multiple different distribution facilities: identify a fixed number of different shipping package sizes to be available; identify multiple different potential packaging combinations; evaluate each of the multiple potential packaging combinations for each of thousands of historic order shipments; obtain a utilization rate of each of the multiple packaging combinations; identify potential packaging combinations that satisfy a utilization threshold, and identify a predicted cost to acquire and utilize each of the identified potential packaging combinations; and select a first potential packaging combination satisfying the utilization threshold and having a lowest predicted utilization cost.

### CROSS-REFERENCE TO RELATED APPLICATION

This application claim the benefit of U.S. Provisional Application No. 62/212,313, filed Aug. 31, 2015, and is incorporated herein by reference in its entirety.

### TECHNICAL FIELD

This invention relates generally to improving product shipments.

### BACKGROUND

Customers often purchase products that are shipped to the customer. In many instances, the products are packaged into a shipping package to be shipped to the customer. The shipping package can add significant costs and/or reduce revenue.

### BRIEF DESCRIPTION OF THE DRAWINGS

Disclosed herein are embodiments of systems, apparatuses and methods pertaining the evaluation and selection of a combination of shipping packages. This description includes drawings, wherein:

FIG. 1 illustrates a simplified block diagram of an exemplary product distribution system, in accordance with some embodiments;

FIG. 2 illustrates a simplified block diagram of an exemplary package evaluation system, in accordance with some embodiments; and

FIG. 3 illustrates a simplified flow diagram of an exemplary process of evaluating potential packages in identifying a package combination of multiple different shipping package types to be used at each of multiple different product distribution facilities.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “some implementations”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to evaluate potential combinations of shipping packages and select a combination of shipping packages to be utilized at one or more distribution facilities. The evaluation of multiple potential packaging combinations allows for the identification of a packaging combination for each particular distribution facility based on past orders that were fulfilled through the respective distribution facility and/or products predicted to be fulfilled through a distribution facility. Further, the evaluation in part reduces waste, and in some instances reduces shipping costs and may increase profits. Still further, the more efficient use of packaging improves customers' experiences. The packages can be substantially any type of package (e.g., envelopes, padded envelopes, boxes, tubes, and other such packaging), substantially any shapes, constructed from substantially any material or combination of materials, and the like. Distribution facilities can be substantially any facility that regularly distributes and/or ships products that are packaged in shipping packages at the distribution facility and shipped from the distribution facility. A distribution facility may be associated with a particular retailer (e.g., a retailer with one or more brick-and-mortar locations, Internet service retailer, etc.), a third party retailer, some manufacturers, and other such facilities that ship products.

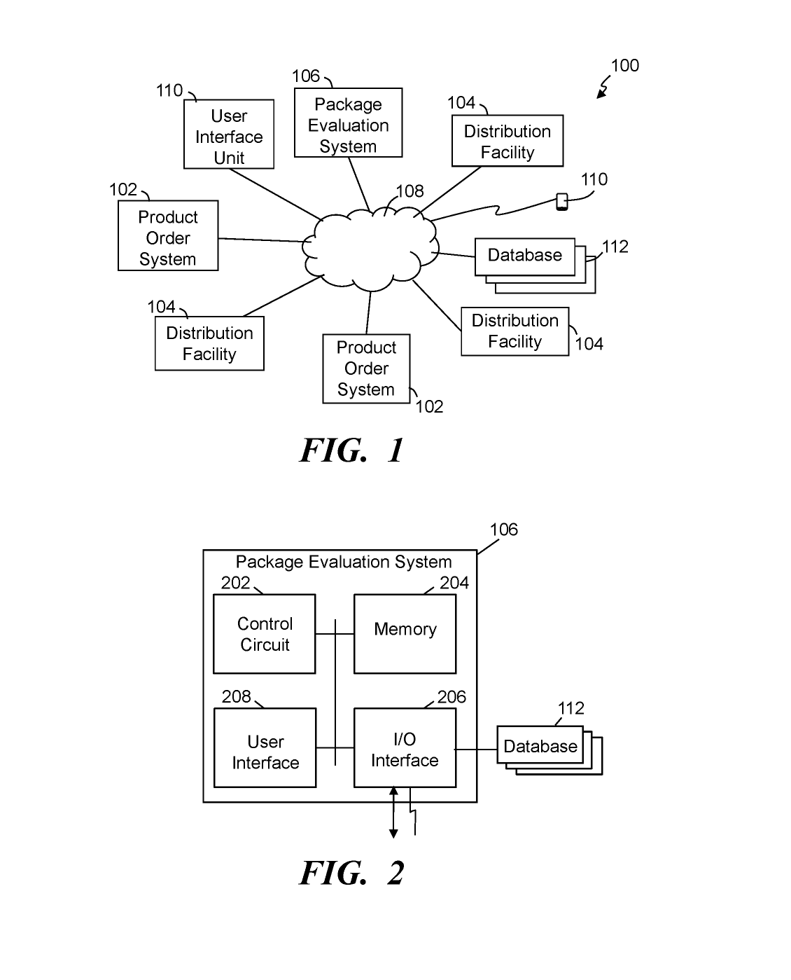

FIG. 1 illustrates a simplified block diagram of an exemplary product distribution system 100, in accordance with some embodiments. The distribution system includes one or more product ordering systems 102, one or more distribution facilities 104, and one or more package evaluation systems 106. The product ordering system 102 is in communication with one or more of the distribution facilities 104 through one or more a wired and/or wireless distributed communication networks 108 (e.g., WAN, LAN, Internet, cellular, other such networks, and combinations of such networks). Multiple customer user interface units (UIU) 110 (e.g., smart phones, cell phones, laptops, tablets, computers, or other such consumer electronic user devices) are typically also in communication with the one or more product order systems over the communication network, such as through a retailer website accessed over the Internet. Typically, the system further includes multiple databases 112 and/or other such computer readable medium that can store relevant data. For example, some embodiments include one or more historic order shipment databases (e.g., storing orders and/or products purchased for multiple purchase orders fulfilled by one or more distribution facilities over one or more predefined periods of time), one or more available packaging inventory databases (e.g., storing packaging information such as, but not limited to, shape, materials, interior and/or exterior dimensions for each available shipment package being considered and/or being utilized that are configured to receive one or more products to be shipped to customers, etc.), one or more product databases (e.g., storing product information such as but not limited to, product identifiers, product dimensions defining dimensions of a product, dimensions of a product and marketing packaging, recommended protection and/or fill packaging to use (e.g., based on a fragility rating), and other such product information), and/or other such databases.

Customers access the product ordering system 102 to purchase products that are to be shipped to the customers. The product ordering system receives confirmation of one or more purchased products for each order. The order is evaluated and one or more distribution facilities are selected to package and ship the one or more products of each product order. The selection may be based on an availability of one or more ordered products at the distribution facilities, the proximity of a distribution facility to a delivery address, cost of distribution from a distribution facility to a delivery address, the cost of delivery in splitting up the order between two or more distribution facilities, time to deliver the one or more products to the customer, other such factors and typically a combination of two or more of such relevant factors. The product ordering system notifies the respective distribution facilities which in turn package and ship the one or more products to the customer.

Again, the cost to distribute products is affected by the shipping packages used. Accordingly, the package evaluation system 106 evaluates shipping packages at each of the multiple distribution facilities and selects a combination of different shipping packages to be used at a distribution facility in shipping products based on hundreds of thousands of orders fulfilled by each respective distribution facility. The selected combination of different shipping packages at a distribution facility attempts to improve the effective volumetric use or utilization rate of packages relative to products shipped from each distribution facility.

There are thousands of types, sizes and shapes of shipping packages that could potentially be used at a distribution facility. Distribution facilities, however, do not have space available to store thousands of different types, sizes and shapes of shipping packages. Accordingly, each distribution facility has a limited or fixed number shipping packages that the distribution facility typically stocks to be used in shipping products from the hundreds of thousands of product orders that are at least partially satisfied through each particular distribution facility. Limiting the number of packages available at a distribution facility in part greatly reduces the storage of rarely used types of shipping packages, provides a more effective use of space at a distribution facility, and simplifies the shipping process.

Because of the limit of having the fixed number of shipping packages the effective volumetric utilization of packages is less than it would be when more types and/or sizes of shipping packages are available at the distribution facilities. Accordingly, in some embodiments the package evaluation system 106 evaluates the hundreds or thousands of shipping packages that might be uses at each of the distribution facilities in selecting a combination of different shipping packages that is limited by the fixed number of shipping packages for each distribution facility.

FIG. 2 illustrates a simplified block diagram of an exemplary package evaluation system 106, in accordance with some embodiments. In this example, the package evaluation system 106 includes a control circuit 202, memory 204, and input/output (I/O) interfaces 206. Further, the package evaluation system typically includes one or more user interfaces 208 configured to allow associates, workers, users and the like to interact with the package evaluation system (e.g., implementing the system, entering data, maintaining the system, updating the system, and the like). Additionally, the package evaluation system may include a power supply (not shown) and/or it may receive power from an external source. In some embodiments, the package evaluation system and/or the control circuit 202 can be implemented through one or more processors and/or distributed servers. The one or more servers may be implemented independent of a distribution facility, or as part of the product ordering systems and/or distribution systems. In some embodiments, the package evaluation system is implemented through a plurality of computers and/or servers that are distributed over one or more communication networks (e.g., the communication network 108), and may be geographically distributed while still being communication coupled to cooperatively operate to perform the functions of the package evaluation system.

The control circuit 202 typically comprises one or more processors and/or microprocessors. The control circuit couples with and/or includes the memory 204. Generally, the memory 204 stores the operational code or set of instructions that are executed by the control circuit 202 and/or processor to implement the functionality of the package evaluation system. In some embodiments, the memory 204 may also store some or all of particular data and code to evaluate product orders relative to shipping packages, the effective use of shipping packages, and the like. Such data may be pre-stored in the memory or be received, for example, from one or more databases 112, distribution facilities 104, shipping package supplier, inventory systems, point of sale systems, shopping facility systems, customer user interface units, other sources, or combinations of two or more of such sources. It is understood that the control circuit may be implemented as one or more processor devices as are well known in the art. Further, the control circuit may be implemented through multiple processors dispersed over the distributed network.

Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the package evaluation system; however, the memory 204 can be internal, external or a combination of internal and external memory. In some instances, the control circuit 202 and the memory 204 may be integrated together, such as in a microcontroller, application specification integrated circuit, field programmable gate array or other such device, or may be separate devices coupled together. In some applications, the control circuit 202 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 206 allow wired and/or wireless communication coupling of the package evaluation system to external components, such as the product order systems 102, distribution facilities 104, databased 112, and other such components. Accordingly, the I/O interface 206 may include any known wired and/or wireless interfacing device, circuit and/or connecting device, such as but not limited to transceivers, receivers, transmitters, and the like. For example, in some implementations, the I/O interface 206 provides wireless communication in accordance with one or more wireless protocols (e.g., Wi-Fi, Bluetooth, radio frequency (RF), cellular, other such wireless communication, or combinations of such communication). In some implementations, the I/O interface includes one or more transceivers configured to couple with and receive communications from over the distributed communication network 108.

One or more user interfaces 208 can be included in and/or coupled with the package evaluation system 106, and can include substantially any known input device, such one or more buttons, knobs, selectors, switches, keys, touch input surfaces and/or displays, etc. Additionally, the user interface may include one or more output display devices, such as lights, visual indicators, display screens, etc. to convey information to a user, such as status information, history information, shipping package information, shipping history, product order history data, package utilization rates, notifications, errors, conditions and/or other such information. While FIG. 2 illustrates the various components being coupled together via a bus, it is understood that the various components may actually be coupled to the control circuit 202 and/or one or more other components directly.

As described above, the package evaluation system is configured to evaluate hundreds or more different shipping packages of differing types (e.g., differing by size, shape, material, etc.). Again, distribution facilities typically cannot store hundreds of different types of shipping packages. Instead, distribution facilities typically use a fixed number of types of packages. Accordingly, some embodiments identify different potential packaging combinations corresponding to the fixed number of packages. These potential package combinations can then be evaluated to identify a combination of packages that would be beneficial for the distribution facility to utilize.

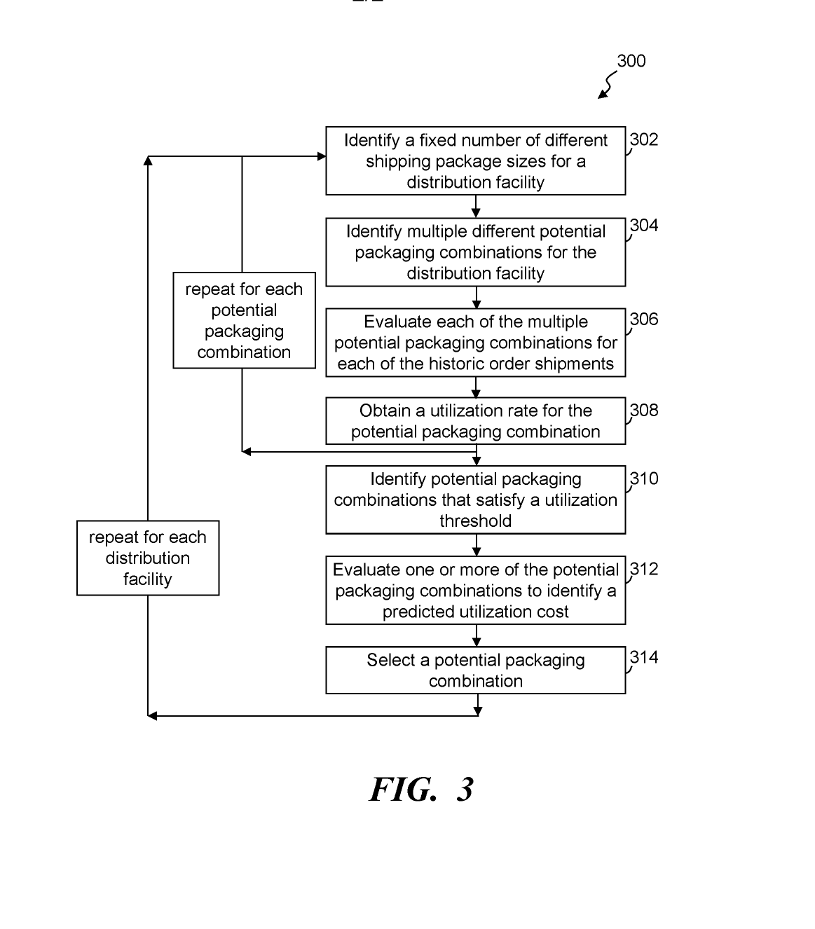

FIG. 3 illustrates a simplified flow diagram of an exemplary process 300 of evaluating potential packages in identifying a package combination of multiple different shipping package types to be used at each of multiple different product distribution facilities. Again, each distribution facility fulfills product orders by shipping one or more products in one or more shipping packages for each product order fulfilled by the distribution facility. Typically, the product orders are orders for one or more products being purchased by customers. Further, in some implementations, the process 300 is implemented for each distribution facility that is evaluated in identifying a desired combination of shipping packages to be used by that distribution facility. In step 302, a fixed number of different shipping packages (e.g., based on sizes, shapes, etc.) to be available at the distribution facility being evaluated is identified. For example, a distribution facility may utilize five, ten, fifteen or some other number of different types of shipping packages available to be used at the distribution facility to ship products for the received product orders. The packages may be different based on size, shape, material, other such factors, or a combination of such factors.

In step 304, multiple different potential packaging combinations are identified from the different available shipping packages. In some embodiments, each of the different potential packaging combinations has the fixed number of different packages. The packages of the potential packaging combinations may, in some instances, be based on size of packages such that each combination has the fixed number of different size shipping packages. Again, the fixed number is typically a relatively small subset of the available shipping packages and/or packaging sizes such that the different available shipping packages is greater than the fixed number.

In some embodiments, one or more parameters and/or criteria are applied to the available packaging in identifying the different potential packaging combinations. The one or more criteria can be dependent on the products being shipped from a distribution facility, the methods of shipment, types of packaging and/or cushioning materials utilized at the distribution facility, sizes of the available packaging and/or groupings of sizes of available packaging, other such criteria, and typically a combination of two or more of such criteria. Further, one or more particular packages or package sizes may be pre-selected such that each potential packaging combination includes the pre-selected one or more packages along with other non-pre-selected packages identified from the available packages.

In some instances, the package evaluation system further groups the plurality of different available shipping packaging and/or package sizes into multiple different groups, such as, but not limited to, groups according to size and/or volume, type of material, general shape, or other such grouping. For example, multiple groups of available packages can be grouped such that each grouping can include a plurality of packaging with different ranges of sizes and/or types. As one more specific and non-limiting example, the available packaging may be grouped into seven different groups (e.g., a very small volume group, a small volume group, a medium-small volume group, a medium volume group, a medium-large volume group, a large volume group, and an extra-large volume group), which may be dependent on specific products being distributed from the distribution facility. Further, the grouping may be based on volume of each shipping package, a maximum dimension in one axis, a maximum area according to two dimensions, other such factors, or combination of two or more of such factors. One or more dividers or thresholds can be defined or selected to designate the different groups of the available packages (e.g., volumes less than Z; volumes between Z and Y; volumes between Y and X; volumes between X and W; volumes between W and V; and volumes greater than V).

In some embodiments, the identification of the multiple different potential packaging combinations may further include identifying a limited subset of the plurality of different available shipping packaging sizes from which the multiple potential packaging combinations are identified such that each potential packaging combination includes at least one shipping packaging size from each of the multiple different groups. As an example, the available different shipping packages may include 200 packages with different shapes and/or volumes. The 200 packages may be grouped into ten groups each with multiple different packages, and each determined potential packaging combination can be defined to include one package from each of the ten groups. Further in some implementations, the number of groups corresponds to the fixed number of packages that are intended to be utilized at the distribution facility being evaluated. As such, the package evaluation system, in grouping the plurality of different available shipping packaging sizes, may define a number of groups equal to the fixed number of different shipping package sizes to be available at the distribution facility. Accordingly, in the example above, the ten groups correspond to the condition that the distribution facility being evaluated intends to utilize ten different shipping packages, and each product order or portion of product order to be fulfilled from that distribution facility would use one of the ten packages from the eventual package combination selected for that distribution facility.

In some implementations the number of available packages may be reduced based on the one or more criteria. For example, some implementations and/or for some distribution facilities would require that a smallest package be greater than a certain volume; a largest package be less than a certain volume; a largest package has to have a length greater than a predefined length; a largest package must have an area greater than a predefined area; at least two shipping package types must be of a certain type or shape; and other such criteria. As such, the packaging evaluation system may reduce the total number of available shipping packages from which the packaging combinations are selected as a function of the one or more criteria. Again, the reduced number of available shipping packages may still be grouped, such as based on the fixed number of packages the intended distribution facility is going to be using. Additionally or alternatively, as introduced above, some implementations may further require that each group include one or more pre-selected packages. For example, there may be for example 200 available packages numbered 1-200, and for one or more reasons package numbers 10 and 35 are pre-selected to be included in the final selected package combination. As such, each potential package combination defined by the package evaluation system would include package numbers 10 and 35, in addition to other packages according to the fixed number. In some instances, the pre-selected packages may represent the group of packages into which that pre-selected package is specified, while in other instances, one or more other packages may be selected from the group in which the pre-selected package is specified. The pre-selection may be based on one or more factors such as, but not limited to, products distributed, cost, historic use, size of package relative to one or more highly ordered specific products, a set maximum or minimum package size, other such factors, or combination of two or more of such factors.

Still referring to FIG. 3, in step 306 each of the multiple potential packaging combinations are evaluated for each of thousands of historic order shipments, and typically hundreds of thousands or more historic order shipments previously fulfilled from the distribution facility being evaluated over one or more predefined periods of time (which may be limited to a threshold of most recent order shipments, a threshold most recent amount of time, etc.). In some implementations, the evaluation includes at least an evaluation based on product dimensions of each product shipped in each product order relative to an interior dimension of one or more of the shipment packages of each the potential packaging combinations. This can include identifying which packages of the packaging combination being evaluated that the one or more products would have fit into for shipment. Some embodiments in evaluating each of the multiple potential packaging combinations further identify each shipping package of the packaging combinations that has a length greater than a greatest length of any of the one or more products of the order shipment being evaluated (and typically greater by at least a length threshold, e.g., 0.25 inches), a width greater than a greatest width of any of the one or more products of the order shipment being evaluated (and typically greater by at least a width threshold), and/or a depth greater than a greatest depth of any of the one or more products of the order shipment being evaluated (and typically greater by at least a depth threshold). Additionally or alternatively, some embodiments identify the one or more shipping packages of the packaging combination being evaluated that further has an interior volume greater than a sum of volumes of the one or more products of the order shipment being evaluated (and typically greater by at least a volume threshold), and in some instances greater by at least the volume threshold than a sum of volumes of all of the products of the order shipment being evaluated. Accordingly, the evaluation can exclude from one or more shipping packaging combinations one or more packages into which at least one, and often all of the products of the order shipment being evaluated.

In step 308, a utilization rate or fill rate is obtained for each of the multiple potential packaging combinations based on the evaluation of the previous order shipments evaluated. The utilization rate corresponds to an amount or percentage of volume occupied by the one or more products relative to a total interior volume of a particular shipping package. Some embodiments obtain a volume of each product as a maximum product volume determined as a multiple of a product's maximum length, width and depth (including any marketing packaging when relevant). In other instances, some implementations take into consideration voids in marketing packaging, such as when two or more products can be nested or positioned relative to each other such that their combined volume may be less than a sum of their maximum volume. The volumes of the one or more products of a shipping order are summed and a total product volume for an order shipment can be determined. Again, in some instances, the total product volume may be less than a sum of maximum volumes when reduced volume of two or more products can be achieved through positioning and such reduced volume is elected to be taken into consideration. Often, however, it cannot be guaranteed that such reduced cooperative volume will be utilized (e.g., because a person packing the products may not nest the products), and as such, some embodiments consider the total product volume as a sum of the maximum product volumes.

In some implementations, the evaluation typically attempts to identify a single shipping package into which all products of an order shipment could have been shipped, and as such identifies each of the shipping packages of a potential packaging combination that can receive all of the products of the order shipment. Other implementations, however, the evaluation considers products of an order shipment that could have been distributed amongst multiple shipping packages of the potential packaging combination being evaluated. A utilization rate is determined for each shipping package (or for the two or more packages when two or more packages are used for a single order shipment). Again, in some instances, the utilization rate is a ratio of the total product volume of the one or more products that would have been placed in a shipping package relative to the interior and/or usable volume of the package or packages being considered in the potential packaging combination being evaluated. Some implementations may further take into consideration a volume of a void fill material when it is determined at least certain minimum void fill material would have been included (e.g., based on how fragile a product was, based on a typical packaging procedure, etc.). Typically, for each of the historic order shipments considered, a best utilization rate is identified for each potential packaging combination. The best utilization rate being the utilization rate closest to and not exceeding 100%.

Again, in step 308 a predicted utilization rate or fill rate is obtained for each of the multiple potential packaging combinations. In some implementations this predicted utilization rate of the potential packaging combination is a single value. For example, the utilization rate of each potential packaging combination may be determined as an average or mean of the utilization rates determined for each of the historic order shipments and for that potential packaging combination. In other instances, a median utilization rate is used, and/or other adjustments may be considered (e.g., excluding utilization rates three standard deviations or more from a mean). In some embodiments, a predicted order shipment utilization rate for each order shipment evaluated is obtained and/or determined for each potential package combination, with the predicted order shipment utilization rates defining a percentage of an interior volume of a selected shipping package size of a potential packaging combination being evaluated that would have been utilized in shipping the products of a historic order shipment. An average of the predicted order shipment utilization rates can then be obtained and/or determined for each of the multiple potential packaging combinations. As a further example, when one-hundred thousand utilization rates are determined for each potential packaging combination relative to one-hundred thousand historic order shipments considered, a utilization rate for the potential packaging combination can be determined, in at least some implementations, as an average utilization rate of the one-hundred thousand utilization rates for that potential packaging combination being evaluated.

Typically, steps 302-308 are repeated for each potential packaging combination that is to be evaluated. Accordingly, a utilization rate is obtained for each potential packaging combination. The different potential packaging combinations and their utilization rates can then be evaluated.

In some embodiments, the process 300 includes step 310 where potential packaging combinations and/or the utilization rates of potential packaging combinations are identified that satisfy (e.g., greater than or equal to) a utilization threshold corresponding to the utilization rates. Typically, the utilization threshold is such that two or more potential packaging combinations satisfy the utilization threshold. In some implementations, the utilization threshold is dependent on the utilization rates of the potential packaging combinations (e.g., a gap, delineation or other factor is detected between different potential packaging combinations, the utilization rates tend to be relatively low, the fixed number is relatively low, or other such factors). In other implementations, the utilization threshold rate may be defined at a level of utilization that is attempting to be achieved for one or more reasons (e.g., marketing, cost, etc.). Still further, the utilization threshold may further depend on cost variation between different identified utilization rates. Other factors may be considered in setting the utilization threshold.

Some embodiments further include step 312, where one or more of the potential packaging combinations, and typically those that have a utilization rate that satisfies the utilization threshold, are evaluated relative to one or more factors. These factors can include cost of purchasing the shipping packages of the packaging combinations, anticipated cost of void fill material (which can be dependent on the utilization rate, fragileness of products, etc.), shipping costs, amount of storage needed for the different potential packaging combinations, availability of packages for the different potential packaging combinations, durability of different packages of the potential packaging combinations, other such factors, or a combination of two or more of such factors. In some implementations, for example, those potential packaging combinations that have a utilization rate greater than a utilization threshold are evaluated to identify a predicted cost to acquire and utilize each of the identified two or more potential packaging combinations. The predicted cost can include, for example, predicted cost to purchase the packages, predicted cost of void fill material (e.g., based on average utilization rates), predicted cost of tape and/or other such closing material, predicted cost in shipping different packages, other such predicted costs, and typically a combination of two or more of such predicted costs.

In step 314, a potential packaging combination of the multiple potential packaging combinations is selected as the combination to be used with respect to the distribution facility being evaluated. The selection may be based on cost, may be based on expected customer satisfaction, may be based on ease of acquiring the packaging, may be based on cost and/or difficulty in storing packages, may be based on expected difficulty in using one or more packages, other such factors, or a combination of two or more of such factors. For example, in some embodiments, a potential packaging combination is selected that satisfies the utilization threshold and has a lowest predicted utilization cost. Again, the utilization cost may include one or more of the predicted cost to purchase the packages, void fill material, tape and/or other such closing material, shipping costs, and other such costs. Based on the selected package combination, in some implementations the package evaluation system further identifies a quantity of packages of each package of the selected packaging combination to order for a given distribution facility and orders relevant quantities of each of the packages of the selected package combination. These quantities may again be based on an evaluation of historic orders for one or more periods of time and the percentage of order shipments that would have utilized each of the packages of the packaging combination.

It is noted that the process 300 may be repeated any number of times for any number of distribution facilities, and/or repeated over time for one or more distribution facilities to continue to monitor packaging use in attempts improve and optimize shipping and/or reduce costs in shipping products to customers. Similarly, the process may be repeated for one or more distribution facilities in response to one or more factors such as, but not limited to, different packages becoming available, changes in cost to use one or more packages, changes in cost to use fill material, changes in one or more products distributed from a distribution facility, or other such factors. Further, the process may be repeated based on a schedule, prior to ordering additional packages for a distribution facility, or the like. As such, the process quickly evaluates thousands and typically hundreds of thousands of historic order shipments from a distribution facility relative to numerous different available packages to identify a combination of shipping packages to be used at a shopping facility to improve utilization rates, and in some instances reduce costs. Further, this process can be repeated any number of times (e.g., monthly, weekly, daily, etc.) to continue to improve utilization and/or adapt to changing product demands as demand varies (e.g., varies during a year, during a month, etc.).

Accordingly, some embodiments evaluate large numbers of available shipping packages, and from these identifies a combination of shipping packages that provides a relatively high level of effective use of packaging volume while attempting to reduce costs, and in some instances optimize costs. Further the optimization of costs may result in a reduction in the efficient use of packaging volumes, however, such reductions are typically minimal and often less than 5%, and in many instances less than 1% over another potential packaging combination. The selection of a package combination typically is based on historic order shipments fulfilled through the respective distribution facilities providing packaging combinations relevant to the specific distribution facilities. Packaging type (e.g., size, make, shape, etc.) can be very important, relating to: package cost, void fill cost, tape cost, shipping/transportation cost, product damage rate, customer experience, and other such factors. As such, the selection of a combination of packages to be used at a distribution facility can have significant effect on cost and customer experience.

Often distribution facilities use shipping packages that are under-utilized and/or add cost to the shipment of products. Some embodiments, however, provide effective evaluation of available packages in identifying a combination of packages specific to a distribution facility based on products typically shipped from the distribution facility, while improving utilization of the packages of the combination, and often reduce shipping costs. In some implementations, the package evaluation system evaluates different package combinations and provides one or more recommendations for one or more package combinations based on package utilization rate and/or fill rate. Further, some embodiments additionally evaluate package combinations based on one or more other factors such as, but not limited to, cost, material, appearance, durability, other such factors, or combination of such factors. Again, the evaluation of available packages and/or potential package combinations can be repeated over time (e.g., prior to ordering packages, periodically scheduled, in response to changing conditions (e.g., change in availability of one or more packages, change in cost of one or more packages, change in customer preferences, marketing issues, etc.), or other reasons.

In some embodiments, apparatuses and methods are provided herein useful to evaluate shipping packaging used at a distribution facility. In some embodiments, system providing packaging evaluations, comprises: an evaluation control circuit and memory coupled to the control circuit storing computer instructions that when executed by the control circuit cause the control circuit to: for each of multiple different distribution facilities: identify a fixed number of different shipping package sizes to be available at the distribution facility; identify multiple different potential packaging combinations from a plurality of different available shipping packaging sizes, wherein the different potential packaging combinations each have the corresponding fixed number of the plurality of different available shipping packaging sizes, and the plurality of different available shipping packaging sizes is greater than the corresponding fixed number; evaluate each of the multiple potential packaging combinations for each of thousands of historic order shipments fulfilled from the distribution facility over one or more predefined periods of time based on the product dimensions of each product in each product order relative to an interior dimension of one or more of the shipment packages of the potential packaging combination being evaluated; obtain a utilization rate of each of the multiple packaging combinations based on the evaluation of each of the thousands of historic order shipments; identify two or more of the multiple potential packaging combinations that satisfy a utilization threshold corresponding to the utilization rates, and identify a predicted cost to acquire and utilize each of the identified two or more potential packaging combinations; and select a first potential packaging combination of the multiple potential packaging combinations satisfying the utilization threshold and having a lowest predicted utilization cost.

In some embodiments, an apparatus and a corresponding method performed by the apparatus, comprises: for each of multiple different distribution facilities: identifying a fixed number of different shipping package sizes to be available at the distribution facility; identifying multiple different potential packaging combinations from a plurality of different available shipping packaging sizes, wherein the different potential packaging combinations each have the corresponding fixed number of the plurality of different available shipping packaging sizes, and the plurality of different available shipping packaging sizes is greater than the corresponding fixed number; evaluating each of the multiple potential packaging combinations for each of thousands of historic order shipments fulfilled from the distribution facility over one or more predefined periods of time based on the product dimensions of each product in each product order relative to an interior dimension of one or more of the shipment packages of the potential packaging combination being evaluated; obtaining a utilization rate of each of the multiple packaging combinations based on the evaluation of each of the thousands of historic order shipments; identifying two or more of the multiple potential packaging combinations that satisfy a utilization threshold corresponding to the utilization rates, and identify a predicted cost to acquire and utilize each of the identified two or more potential packaging combinations; and selecting a first potential packaging combination of the multiple potential packaging combinations satisfying the utilization threshold and having a lowest predicted utilization cost.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system providing packaging evaluations, comprising:
an evaluation control circuit and memory coupled to the control circuit storing computer instructions that when executed by the control circuit cause the control circuit to:
for each of multiple different distribution facilities:
identify a fixed number of different shipping package sizes to be available at the distribution facility;
identify multiple different potential packaging combinations from a plurality of different available shipping packaging sizes, wherein the different potential packaging combinations each have the corresponding fixed number of the plurality of different available shipping packaging sizes, and the plurality of different available shipping packaging sizes is greater than the corresponding fixed number;
evaluate each of the multiple potential packaging combinations for each of thousands of historic order shipments fulfilled from the distribution facility over one or more predefined periods of time based on the product dimensions of each product in each product order relative to an interior dimension of one or more of the shipment packages of the potential packaging combination being evaluated;
obtain a utilization rate of each of the multiple packaging combinations based on the evaluation of each of the thousands of historic order shipments;
identify two or more of the multiple potential packaging combinations that satisfy a utilization threshold corresponding to the utilization rates, and identify a predicted cost to acquire and utilize each of the identified two or more potential packaging combinations; and
select a first potential packaging combination of the multiple potential packaging combinations satisfying the utilization threshold and having a lowest predicted utilization cost.

2. The system of claim 1, wherein the control circuit in obtaining the utilization rate of each of the multiple potential packaging combinations is further configured to:
obtain, for each order shipment evaluated for each potential package combination, predicted order shipment utilization rates defining a percentage of an interior volume of a selected shipping package size of a potential packaging combination being evaluated that would have been utilized in shipping the products of an order shipment; and
obtain an average of the predicted order shipment utilization rates for each of the multiple potential packaging combinations.

3. The system of claim 1, wherein the control circuit in evaluating each of the multiple potential packaging combinations is further configured to identify a first shipping package that has a length, width, and depth that are greater than: a greatest length any of the one or more products of the order shipment being evaluated, a greatest width of any of the one or more products of the order shipment being evaluated, and a greatest depth of any of the one or more products of the order shipment being evaluated.

4. The system of claim 3, wherein the control circuit in evaluating each of the multiple potential packaging combinations is further configured to identify the first shipping package that further has an interior volume greater than a sum of volumes of all of the products of the order shipment being evaluated.

5. The system of claim 1, wherein the control circuit is further configured to group the plurality of different available shipping packaging sizes into multiple different groups according to size, and in the identifying multiple different potential packaging combinations further identifies a limited subset of the plurality of different available shipping packaging sizes from which the multiple potential packaging combinations are identified such that each potential packaging combination includes at least one shipping packaging size from each of the multiple different groups.

6. The system of claim 5, wherein the control circuit in grouping the plurality of different available shipping packaging sizes defines a number of groups equal to the fixed number of different shipping package sizes to be available at the distribution facility.

7. A method of evaluating package combinations, comprising:
by an evaluation control circuit:
for each of multiple different distribution facilities:
identifying a fixed number of different shipping package sizes to be available at the distribution facility;
identifying multiple different potential packaging combinations from a plurality of different available shipping packaging sizes, wherein the different potential packaging combinations each have the corresponding fixed number of the plurality of different available shipping packaging sizes, and the plurality of different available shipping packaging sizes is greater than the corresponding fixed number;
evaluating each of the multiple potential packaging combinations for each of thousands of historic order shipments fulfilled from the distribution facility over one or more predefined periods of time based on the product dimensions of each product in each product order relative to an interior dimension of one or more of the shipment packages of the potential packaging combination being evaluated;
obtaining a utilization rate of each of the multiple packaging combinations based on the evaluation of each of the thousands of historic order shipments;
identifying two or more of the multiple potential packaging combinations that satisfy a utilization threshold corresponding to the utilization rates, and identify a predicted cost to acquire and utilize each of the identified two or more potential packaging combinations; and
selecting a first potential packaging combination of the multiple potential packaging combinations satisfying the utilization threshold and having a lowest predicted utilization cost.

8. The method of claim 7, wherein the obtaining the utilization rate of each of the multiple potential packaging combinations further comprises:
obtaining, for each order shipment evaluated for each potential package combination, predicted order shipment utilization rates defining a percentage of an interior volume of a selected shipping package size of a potential packaging combination being evaluated that would have been utilized in shipping the products of an order shipment; and
obtaining an average of the predicted order shipment utilization rates for each of the multiple potential packaging combinations.

9. The method of claim 7, wherein the evaluating each of the multiple potential packaging combinations further comprises:
identifying a first shipping package that has a length, width, and depth that are greater than: a greatest length any of the one or more products of the order shipment being evaluated, a greatest width of any of the one or more products of the order shipment being evaluated, and a greatest depth of any of the one or more products of the order shipment being evaluated.

10. The method of claim 9, wherein the evaluating each of the multiple potential packaging combinations further comprises:
identifying the first shipping package that further has an interior volume greater than a sum of volumes of all of the products of the order shipment being evaluated.

11. The method of claim 7, further comprising:
grouping the plurality of different available shipping packaging sizes into multiple different groups according to size;
wherein the identifying the multiple different potential packaging combinations further comprises identifying a limited subset of the plurality of different available shipping packaging sizes from which the multiple potential packaging combinations are identified such that each potential packaging combination includes at least one shipping packaging size from each of the multiple different groups.

12. The method of claim 11, wherein the grouping the plurality of different available shipping packaging sizes comprises defining a number of groups equal to the fixed number of different shipping package sizes to be available at the distribution facility.
